(19) United States
(12) Patent Application Publication
(10) Pub. No.: US 2005/0117457 A1
(43) Pub. Date: Jun. 2, 2005

(54) Worldwide solar calendar and phases of the moon of watches

(76) Inventors: Adolphe Richard Dziulko, Le Perreux (FR); Alice Dziulko, La Perreux (FR)

Correspondence Address: WESTERMAN, HATTORI, DANIELS & ADRIAN, LLP, 1250 CONNECTICUT AVENUE, NW, SUITE 700, WASHINGTON, DC, 20036, US

(21) Appl. No.: 10/500,333

(22) PCT Filed: Dec. 5, 2002
(86) PCT No.: PCT/FR02/04191

(30) Foreign Application Priority Data
Dec. 13, 2001 (FR) 01/16095

(51) Int. Cl. G04B 19/26

(52) U.S. Cl. 368/18

(57) ABSTRACT

The invention concerns an electronic and mechanical device incorporated in watches and wrist bands enabling double worldwide representation of solar calendar and phases of the moon. The first, pictured on a circular LCD display panel, displays all year round, the day and night evolution at standard time or winter time; the second, digitally displayed, only the standard sunset time. The mechanical part adapts the phases of the moon to the two hemispheres.

The first important watch-making realization dates back to 1301, and is the work of Canon Etienne Musique. This large watch in the cathedral of Beauvais already displays the phases of the moon which help in selecting religious songs. In this same cathedral, five centuries later, an engineer, Lucien Verite, completed in 1868 an astronomical watch with an assembly of 90,000 parts for 68 automats and 52 dials, 2 of which are for sunrises and sunsets and another one is for the phases of the moon. These two watches still work, and keep impressing the faithful and the visitor. Closer to us, the “Calibre 89” by Patek Philippe indicates sunrises and sunsets among 32 other complications, the last one, “Star Caliber 2000”, integrates six new inventions and determines mechanically sunsets and sunrises as well as the phases and the orbit of the moon. It is made in 20 copies with five sets of four watches.

There has always been on the market astronomical solar and lunar watches. However, even though it may be easy to control the phases of the moon, a satisfactory mechanical or even electronic solution to the extreme complexity of solar ephemeris has not yet been found.

The present invention consists in integrating into any watch, even the most luxurious and reticent to digital manipulations, some electronics in order to display all the sunsets and sunrises, over the whole earth, without any number to support it. The first solution, imaged, consists in a circular LCD screen located at the periphery of the 24 hour dial on which, along with the evolution of seasons, an image of the night is shown between the sunset time and the sunrise time. The second solution, derived from the first, consists in displaying on the window (2) only the digital sunset times.

Concerning the phases of the moon, valid for both hemispheres, it is an additional complication added to the patent FR 2,790,564 that enables this performance.

The technique which enables the microprocessor to position, day after day, within the programmed limit, the image of the night according to solar time corresponds to a system that takes into account two parameters: the symbol of a parallel 60° N and the sumbol of the day on the date window (1.1). These two pieces of information implicate automatically a third one, which is the sunset time at that latitude, at the solar time, a time schedule valid for centuries. The sunset table on three parallels has been made based on the data gathered by the Bureau of Longitudes at the Paris Observatory, founded in 1794. The first and fourth columns display, starting at January first, the days along the year which correspond to 5 minute advances of the sunset time. The number of the latitude is selected and can vary according to the choice of the watch-makers.

The second part of the technique consists in selecting regular time schedule changes, every five minutes, at irregular numbers of days, as dictated by these time schedules. These time intervals can vary from one day to three weeks.

The third part consists in attributing to each day of a time schedule change a code number corresponding to the sunset time on that day.

The graduated outside periphery (6) illustrates the relations established between the time schedules of the 24 hour dial, with 12 divisions per hour, and a code system that represents them.

In order to be able to display all the ephemeris at the polar circle, i.e., a progression of the night over 12 hours in 6 months, it is necessary to divide the hours into 12 intervals of 5 minutes, which gives a total number of 144 intervals around the dial. Midnight is represented by the code 0, the twelfth 5 minute interval on the sunset side corresponds to 23:00 and 01:00 at sunrise, code 18 to 22:30 and 01:30, code 72 to 18:00 and 06:00; the sunrises being placed in full symmetry with respect to the sunsets by a derived electronic circuit.

Thus, the proposed system takes finally into account the symbols of a parallel, of a date, and of a code making it possible to display the exact sunset time, but only at the precise location of that parallel with a time reference meridian such as the Greenwich Meridian. Any displacement in any direction from that intersection results in that the display time schedule does no longer correspond to reality.

In order to illustrate the extreme complexity of the global solar ephemeris, the following table presents the changes in the time schedules resulting from moving from East to West:

| | | Displacement = | |
|---|---|---|---|
| | Length | 1 hour = 15° | Distance over 1° = 4 minutes |
| Equator | 40,000 km | 1,666 km | 111 km |
| 40° | 33,000 km | 1,375 km | 91 km |
| 50° | 27,000 km | 1,125 km | 75 km |
| 60° | 21,000 km | 875 km | 58 km |
| 66° (P.C.) | 18,000 km | 750 km | 50 km |

Thus, a displacement of 58 km along the 60° parallel is equivalent to 4 minutes.

Faced with such a situation, no scientific calculation can seriously help, one must trust the only judge, in the circumstance, the sun, by assisting to its sunset in the new location. Then, by entering the correction via the push button (4).

Example: if the sunset on that day was at 15:35 instead of the 15:00 displayed, an extended push on (4) triggers the correction process, then 6 short pushes toward noon advance, for each push, the time schedule by five minutes on the window (2) and by one interval on the screen (1). A last extended push on the push button (4) confirms the correction which becomes permanent for that location. The same push button enables also the adaptation of the two LCD screens, the circular screen and the window, to legal time, according to the same method. These corrections are added to the sunset as well as to the sunrise, which breaks with the symmetry (see Figure).

In summary, here is a watch that, by combining harmoniously mechanics and electronics, has the ambition to become the first astronomical watch at the scale of both hemispheres for any location on the ground or at sea.

This watch is not distinguished from any other, each creator will imprint his or her talent, it has hands that indicates time on a dial that is round, oval, rectangular, day, night, simple or with diamonds, but, in order to justify its astronomical appellation, it must imperatively integrates on the dial a moon that does not take more space than its disc, and that always remains well visible and legible whatever the day or night background (2&3) of the dial.

Such a moon has been the object of a recent patent filed in 1999 and published under the number U.S. Pat. No. 2,790,564. FIG. 3 illustrates the evolution of the phases as drawn by a double cache revolving in a direction contrary to the hands of the watch, between a round cut in the dial and a clear background. This display, however, is only for the northern hemisphere.

Since the solar ephemeris concerns both hemispheres, it is beneficial to grant to the moon also the possibility, at each passage across the equator, to present an inverted image, as seen in a mirror. This is obtained via a winding mechanism (5) which, when pulled or pushed, reverses the rotation direction of the cache, then, by turning it to the right or to the left, makes it possible to actualize the phase, going directly from phase 9 to phase 13 (FIG. 3).

The prestigious watches may not have interest in being manipulated, charged, changed, in which case they may integrate in their wrist band what they hesitate to have done on their dial. The watch of FIG. 4 integrates in the wrist band 3 complications and a battery.

SUNSET TABLE

| 40° LAT N | | | | 50° N | | | | 60° N | | | |
|---|---|---|---|---|---|---|---|---|---|---|---|
| DATE | CODE . . . | | DATE | DATE | CODE . . . | | DATE | DATE | CODE . . . | | DATE |
| 31.12 | 88 | 16.40 | 27.11 | 31.12 | 95 | 16.05 | 24.11 | 25.12 | 108 | 15.00 | 6.12 |
| 1.01 | 87 | 16.45 | 13.11 | 1.01 | 94 | 16.10 | 19.11 | 1.01 | 107 | 15.05 | 28.11 |
| 9.01 | 86 | 16.50 | 7.11 | 8.01 | 93 | 16.15 | 15.11 | 3.01 | 106 | 15.10 | 25.11 |
| 14.01 | 85 | 16.55 | 3.11 | 13.01 | 92 | 16.20 | 11.11 | 6.01 | 105 | 15.15 | 22.11 |
| 18.01 | 84 | 17.00 | 29.10 | 16.01 | 91 | 16.25 | 8.11 | 9.01 | 104 | 15.20 | 20.11 |
| 22.01 | 83 | 17.05 | 26.10 | 19.01 | 90 | 16.30 | 5.11 | 11.01 | 103 | 15.25 | 17.11 |
| 26.01 | 82 | 17.10 | 22.10 | 22.01 | 89 | 16.35 | 13.11 | 13.01 | 102 | 15.30 | 14.11 |
| 30.01 | 81 | 17.15 | 18.10 | 25.01 | 88 | 16.40 | 30.10 | 15.01 | 101 | 15.35 | 12.01 |
| 3.02 | 80 | 17.20 | 15.10 | 28.01 | 87 | 16.45 | 27.10 | 17.01 | 100 | 15.40 | 10.11 |
| 7.02 | 79 | 17.25 | 12.10 | 31.01 | 86 | 16.50 | 24.10 | 20.01 | 99 | 15.45 | 8.11 |
| 12.02 | 78 | 17.30 | 7.10 | 3.02 | 85 | 16.55 | 22.10 | 22.01 | 98 | 15.50 | 6.11 |
| 16.02 | 77 | 17.35 | 4.10 | 6.02 | 84 | 17.00 | 19.10 | 24.01 | 97 | 15.55 | 4.11 |
| 20.02 | 76 | 17.40 | 2.10 | 9.02 | 83 | 17.05 | 16.10 | 20.01 | 96 | 16.00 | 2.11 |
| 25.02 | 75 | 17.45 | 29.09 | 12.02 | 82 | 17.10 | 14.10 | 28.01 | 95 | 16.05 | 31.10 |
| 1.03 | 74 | 17.50 | 26.09 | 15.02 | 81 | 17.15 | 12.10 | 30.01 | 94 | 16.10 | 29.10 |
| 6.03 | 73 | 17.55 | 23.09 | 18.02 | 80 | 17.20 | 10.10 | . . . | . . . | . . . | . . . |
| 10.03 | 72 | 18.00 | 20.09 | 21.02 | 79 | 17.25 | 7.10 | 6.03 | 76 | 17.40 | 28.09 |
| 15.03 | 71 | 18.05 | 17.09 | 24.02 | 78 | 17.30 | 5.10 | 8.03 | 75 | 17.45 | 27.09 |
| 20.03 | 70 | 18.10 | 14.09 | 27.02 | 77 | 17.35 | 2.10 | 10.03 | 74 | 17.50 | 25.09 |
| 25.03 | 69 | 18.15 | 11.09 | 2.03 | 76 | 17.40 | 30.09 | 12.03 | 73 | 17.55 | 24.09 |
| 30.03 | 68 | 18.20 | 8.09 | 5.03 | 75 | 17.45 | 28.09 | 15.03 | 72 | 18.00 | 22.09 |
| 3.04 | 67 | 18.25 | 5.09 | 7.03 | 74 | 17.50 | 25.09 | 16.03 | 71 | 18.05 | 20.09 |
| 8.04 | 66 | 18.30 | 2.09 | 10.03 | 73 | 17.55 | 22.09 | 20.03 | 70 | 18.10 | 19.09 |
| 13.04 | 65 | 18.35 | 29.08 | 14.03 | 72 | 18.00 | 20.09 | 22.03 | 69 | 18.15 | 18.09 |
| 18.04 | 64 | 18.40 | 26.08 | 18.03 | 71 | 18.05 | 17.09 | 24.03 | 68 | 18.20 | 17.09 |
| 23.04 | 63 | 18.45 | 23.08 | . . . | . . . | . . . | . . . | . . . | . . . | . . . | . . . |
| 28.04 | 62 | 18.50 | 19.08 | 12.05 | 54 | 19.30 | 07.08 | 22.05 | 39 | 20.45 | 26.07 |
| 3.05 | 61 | 18.55 | 16.08 | 15.05 | 53 | 19.35 | 04.08 | 25.05 | 38 | 20.50 | 23.07 |
| 8.05 | 60 | 19.00 | 12.08 | 18.05 | 52 | 19.40 | 01.08 | 27.05 | 37 | 20.55 | 20.07 |
| 13.05 | 59 | 19.05 | 8.08 | 22.05 | 51 | 19.45 | 28.07 | 30.06 | 36 | 21.00 | 18.07 |
| 19.05 | 58 | 19.10 | 4.08 | 26.05 | 50 | 19.50 | 24.07 | 2.06 | 35 | 21.05 | 15.07 |
| 24.05 | 57 | 19.15 | 30.07 | 31.05 | 49 | 19.55 | 20.07 | 5.06 | 34 | 21.10 | 12.07 |
| 30.05 | 56 | 19.20 | 25.07 | 5.06 | 48 | 20.00 | 16.07 | 8.06 | 33 | 21.15 | 8.07 |
| 8.06 | 55 | 19.25 | 18.07 | 12.06 | 47 | 20.05 | 12.07 | 13.06 | 32 | 21.20 | 4.07 |
| 17.06 | 54 | 19.30 | | 24.06 | 46 | 20.10 | | 21.06 | 31 | 21.05 | |

1. Electronic and mechanical device, integrated into a watch or wrist band, displaying solar and lunar ephemeris at the planet scale, characterized in that it offers at least one visualization selected among the following possibilities
the first visualization, an image display, displays all along the year the evolution of the duration of the day and of the night according to solar or legal time on an LCD display,
the second visualization, a numerical display, displays on a window the sunset time only,
wherein, in order to give the watch a complete astronomical character, a mechanical or electronic part displays the phases of the moon at the scale of the two hemispheres.

2. Device according to claim 1, wherein the imaged display, without any number, is obtained via a circular LCD screen placed at the periphery of a 24 hour dial of the watch with a dark portion representing the night extending on both sides of midnight at regular intervals of 5 minutes, but at irregular day intervals, as a function of these 5 minutes.

3. Device according to claim 2 wherein the 24 hour dial has each hour divided in 12 intervals by 6 bars thickened to the dimension of the spaces so that the 12 intervals are represented by 6 black spaces alternated with 6 white, the whole being now very legible and visible.

4. Device according to claim 1 wherein a system, which enables the microprocessor to place and keep every day the image of the night within the programmed limits, implicates a symbol of a parallel (60° N) and a day's date, these two pieces of information implicating a third one: the sunset time, on that day on that parallel, if at noon in that location the sun is at its zenith. According to a time schedule, immutable for centuries, being transmitted by a decoder toward a microprocessor via a code.

5. Device according to claim 4, wherein there are 144 code numerals, synonymous to the 5 minute time periods, in order to be able to satisfy the ephemeris at the polar circle, the sunrise being placed automatically in full symmetry with the sunset, at the solar time.

6. Device according to claim 4, wherein, as the time schedules dictated by the symbol of the selected parallel give the exact time only at the intersection of that parallel and the time reference meridian, the difference shown between the display on the screens and the reality of a real sunset at any other location is correctable by a lateral pressure push button.

7. Device according to claim 1, wherein a winding mechanism is adapted in order to have in the southern hemisphere the same evolution toward a “new moon” but in an aspect as seen from a mirror, at each passage across the equator, to reverse the rotation direction of a black double cache by pulling or pushing the winding mechanism, then by screwing or unscrewing it, so as to go directly from the North phase to the South phase, or reciprocally.

8. Device according to claim 1, wherein some complications are located into the wristband.

9. Device according to claim 6, wherein the push button is adapted such that an extended pressure triggers the process, short hits toward noon provide the correction, and a last extended pressure confirms it.
